(19) United States
(12) Patent Application Publication
(10) Pub. No.: US 2002/0185870 A1
(43) Pub. Date: Dec. 12, 2002

(54) Tachyonic prime mover

(76) Inventor: Joseph Richmond Ohngha, San Leandro, CA (US)

Correspondence Address: Joseph Ohngha, 1729 136th Ave, San Leandro, CA, 94578, US

(21) Appl. No.: 09/961,833

(22) Filed: Sep. 25, 2001

Related U.S. Application Data
(60) Provisional application No. 60/297,136, filed on Jun. 11, 2001.

(51) Int. Cl. H02P 9/04

(52) U.S. Cl. 290/1 R

(57) ABSTRACT

The device is a prime mover which runs on water without sepration of the oxygen and hydrogen molecules.

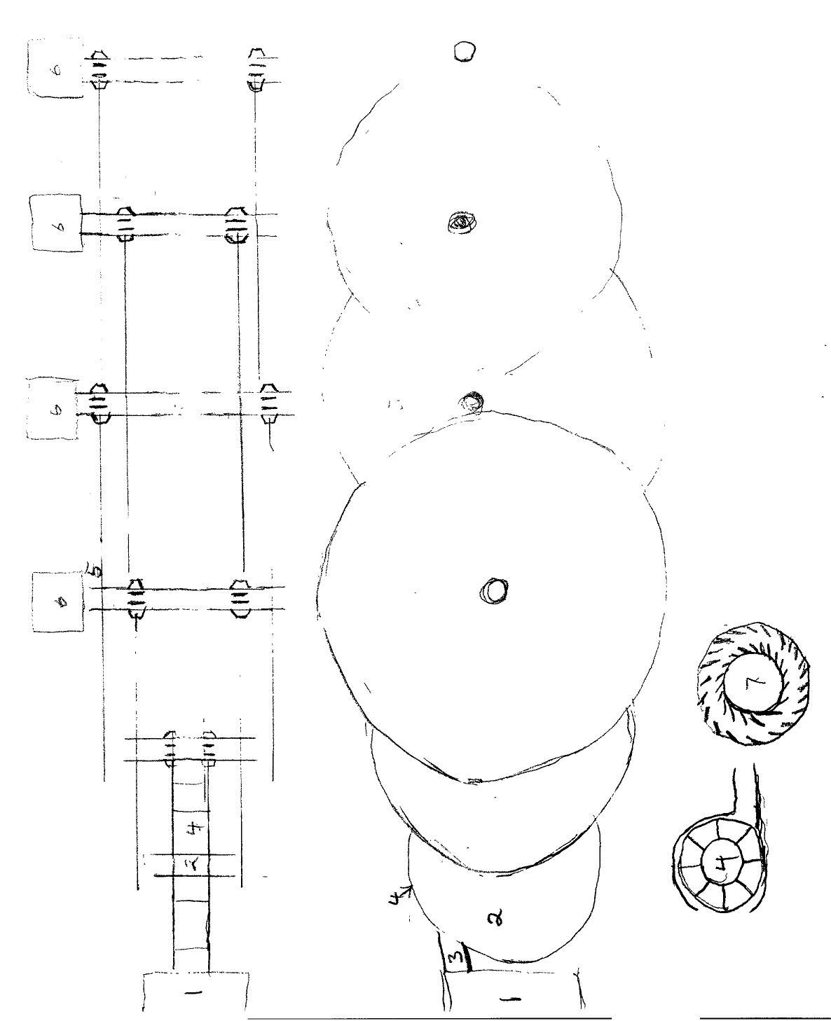

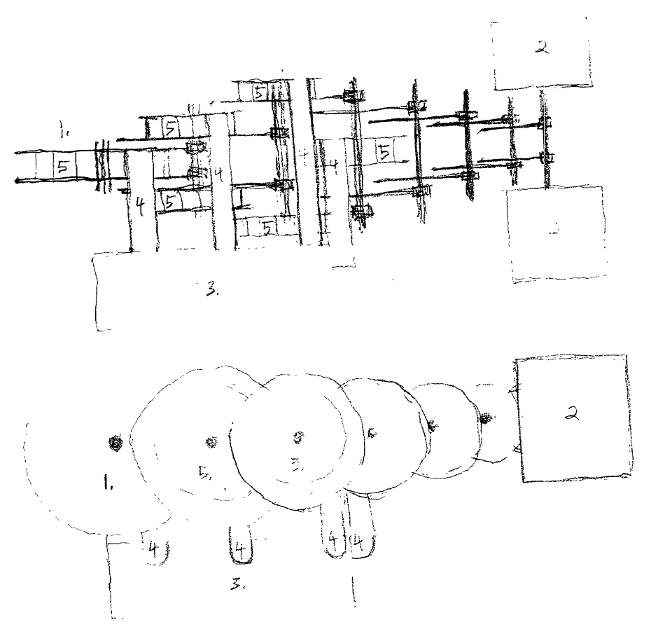

This application claims the benefit of U.S. provisional application No. 60/297,136 filing date Jun. 11, 2001

### BACKGROUND OF THE INVENTION

the field of endeavor is prime m overs. Other movers require fuel, radioactive elements, or other things. My inventi on requires only water and emits only steam.

### BRIEF SUMMARY OF THE INVENTION

The invention uses speed mult iplying mecanisms

### BRIEF DESCRIPTION OF SEVERAL VIEWS OF THE DRAWING

To start t he device a heat source is applied to a tank of water. {1} or another mover spins the gears {2}. steam goes through a pipe {3} and spins a turbine {4} which spins a sieries of speed multiplying gears {5} The rods spin generators {6} which supply power to rev erse thermocouples which boil water into steam {1} the turbine has a mechanism wh ich spins in only one direction {7}

### DETAILED DESCRIPTION OF THE INVENTION

speed multiplying mech anisms spin generators which provide power to reverse thermocouples which heat wate r into steam to spin the turbine. The device requires only water and emits on ly steam. The device should be made of lightweight metal. Space requires the gears to be progresively smaller in diameter to allow use of the rods.

CLAIM or claims 1 claim as my invention the described device or processof using speed multiplying mechanisms to spin generators, which power thermocouples which heat water into steam to spin the turbine.

### BRIEF DESCRIPTION OF SEVERAL VIEWS OF THE DRAWING

To start the device another mover spins the gears (1)which spin generators, producing power which heats a reverse thermocouple inside a tank of water (3). Steam goes through pipes (4) and spins turbines. (5)

1. I claim as my invention the described device.
